(19) United States
(12) Patent Application Publication
(10) Pub. No.: US 2024/0383722 A1
(43) Pub. Date: Nov. 21, 2024

(54) ELEVATOR PUSH BUTTON DEVICE

(71) Applicant: Inventio AG, Hergiswil (CH)

(72) Inventors: Matthias Springer, Wayne, NJ (US); Jonathan Finney, Morristown, NJ (US); David Martell, Morristown, NJ (US); Rei Flores, Morristown, NJ (US)

(21) Appl. No.: 18/694,450

(22) PCT Filed: Sep. 23, 2022
(86) PCT No.: PCT/EP2022/076541

§ 371 Date: Mar. 22, 2024

(30) Foreign Application Priority Data
Sep. 30, 2021 (EP) 21200370.1

(51) Int. Cl. B66B 1/46

(52) U.S. Cl. CPC B66B 1/462; B66B 1/466

(57) ABSTRACT

An elevator pushbutton device has a guide housing and an actuating element disposed within the guide housing. The guide housing is provided with fastening wings, the guide housing and the actuating element are made of metal material, and the guide housing is a monolithic one-piece metal injection molded component.

### FIELD

The invention relates to an elevator pushbutton device comprising a guide housing and an actuating member disposed within the guide housing.

### BACKGROUND

Such elevator pushbutton devices are used, in particular, in elevators used by persons to be conveyed from one floor of a building to another floor of the building. In such elevators, pushbuttons are provided both on the individual floors and in the elevator car, by actuation of which a user's transportation requests can be entered. For example, by actuating a pushbutton located at a floor next to the elevator shaft, the user's request can be signaled that the elevator car be moved to the floor at which the user is currently waiting for the elevator to move from there to another floor. By pressing a pushbutton located inside the elevator car, the user can, for example, specify the floor to which he or she would like to be driven.

Elevator pushbutton devices are already known which comprise a guide housing and an actuating element arranged within the guide housing which can be actuated to enter a user request, and in which the guide housing is made of plastic and the actuating element arranged within the guide housing is made of metal.

Since elevators intended in particular for transporting persons are generally used by a large number of persons, there is a need to clean and also disinfect the elevator pushbutton devices of these elevators at the shortest possible intervals in order to prevent the spread of pathogens. For this disinfection, a disinfectant is used which, if used frequently, can damage the plastic guide housing of the elevator pushbutton device to such an extent that the elevator pushbutton device and thus the elevator as a whole become inoperable. This requires repair of the elevator pushbutton device and/or replacement of the elevator pushbutton device or parts of the elevator pushbutton device in order to restore the functionality of the elevator pushbutton device and thus of the elevator as a whole.

### SUMMARY

An object of the invention is to provide a way to improve the operability of an elevator pushbutton device.

This object is solved by an elevator pushbutton device having the features described below. This elevator pushbutton device comprises a guide housing and an actuating element arranged within the guide housing, wherein the guide housing is provided with fastening wings, the guide housing and the actuating element are made of metal, and the guide housing is a monolithic one-piece metal injection molded component.

In this context, a monolithic one-piece metal injection molded component means not only a component consisting of one type of metal, but also, for example, a component consisting of a metal alloy, a component consisting of a layered metal or a component consisting of light metal.

An advantage of an elevator pushbutton device formed in this way is that its components are not damaged even when disinfectants are used frequently, so that the operability of the elevator pushbutton device and thus also the operability of the entire elevator is maintained over a longer period of time than when using an elevator pushbutton device which has plastic components.

According to an aspect, the guide housing is annular in its upper end portion. If the top surface of the actuating element is aligned with the top surface of the guide housing when the actuating element is not actuated the possibility of disinfectant entering the region between the guide housing and the actuating element of the elevator pushbutton device is minimized.

According to a further aspect, the outer diameter of the annular upper end portion of the guide housing is 3.429 cm+/−0.034 cm and the height of the guide housing extending in the direction of the central axis of the annular upper end portion of the guide housing is 1.905 cm+/−0.019 cm. This has the advantage that an elevator pushbutton device equipped with the features according to the invention can be used to replace or exchange elevator pushbutton devices already in operation.

According to a further aspect, the length of the fastening wings extending parallel to the central axis of the annularly formed upper end portion of the guide housing is 0.863 cm+/−0.009 cm, respectively. This helps to ensure that the finished end product can be manufactured as a metal injection molded component and furthermore has the necessary dimensions for practical use in an elevator system.

According to a further aspect the free length of the fastening wings between the lower end of the central portion of the guide housing and the lower end of the guide housing is 0.558 cm+/−0,006 cm. This aspect also contributes to the fact that the finished end product can be manufactured as a metal injection molded component and furthermore has the necessary dimensioning for practical use in an elevator system.

According to a further aspect, the thickness of the fastening wings extending perpendicular to the central axis of the annularly formed upper end portion of the guide housing is 0.076 cm+/−0.001 cm, respectively. This aspect ensures that the necessary attachment of the fastening wings to an electronic switch device of the elevator pushbutton device can be made in a simple and secure manner.

The above-described design and dimensioning of the fastening wings improves the operability and thus the practicality of the elevator pushbutton device and thus also of the entire elevator, since it is ensured that the fastening wings which are contacted with an electronic switch device of the elevator pushbutton device during operation of the elevator pushbutton device have the properties necessary for operability during operation, namely a necessary strength while at the same time granting a necessary deformability or flexibility.

According to a further aspect, the actuating member is adapted to be pushed from a first side of the elevator pushbutton device. According to a further aspect, the fastening wings extend, along (parallel to) an axis of the pushbutton device. According to a further aspect, the fastening wings extend from a second side of the guide housing axially opposite to the first side and/or in a direction towards the second side from the guide housing. According to a further aspect, the fastening wings are arranged in a regularly spaced manner along an outer circumference of the guide housing. For example, two fastening wings may be arranged at opposite sides on the outer circumference.

According to a further aspect, the fastening wings are, in a cross-sectional view perpendicular to the axis of the pushbutton device, curved along a circumference of the pushbutton device. According to a further aspect, each of the fastening wings extends circumferentially along a respective circumferential section.

According to a further aspect, the fastening wings have an axially outer tip (preferably at a second side of the pushbutton device axially opposite to the first side from which the pushbutton device is adapted to be pushed). According to a further aspect, the tip is thickened according to a radial thickness, in particular thickened relative to a middle section of the fastening wings.

According to a further aspect, the fastening wings are provided for fastening an electronic switch device to the guide housing of the elevator pushbutton device by snapping into an inner side wall of the electronic switch device.

According to a further aspect, the actuating element has a circular pushing surface (facing towards a first side of the pushbutton device). According to a further aspect, the main body of the actuating element is axially glidably arranged within an opening of the guide housing. According to a further aspect, the main body of the actuating element comprises a non-axially-symmetric glider contour for allowing axial gliding of the actuating element in the guide housing while prohibiting a rotation of the actuating element about the axis in the guide housing.

### DESCRIPTION OF THE DRAWINGS

Further advantageous features of the invention will be apparent from the following exemplary description thereof with reference to the figures. It shows:

FIG. 1 is a perspective view showing the components of an elevator pushbutton device necessary for understanding the invention,

FIG. 2 is a top view of the device shown in FIG. 1,

FIG. 3 is a side view of the device shown in FIG. 1,

FIG. 4 is a 90° rotated side view of the device shown in FIG. 1,

FIG. 5 is a perspective view of the guide housing,

FIG. 6 is a sectional view of the guide housing,

FIG. 7 is a perspective view of a guide housing produced by means of a metal injection molding process, viewed obliquely from above,

FIG. 8 is a perspective view of a guide housing produced by means of a metal injection molding process, viewed from obliquely below,

FIG. 9 is a perspective view of the actuating element,

FIG. 10 is a top view of the actuating element shown in FIG. 9,

FIG. 11 is a side view of the actuating element shown in FIG. 9,

FIG. 12 is an exploded view illustrating the attachment of an elevator pushbutton device to an elevator panel and

FIG. 13 is an assembled view of the device shown in FIG. 12.

### DETAILED DESCRIPTION

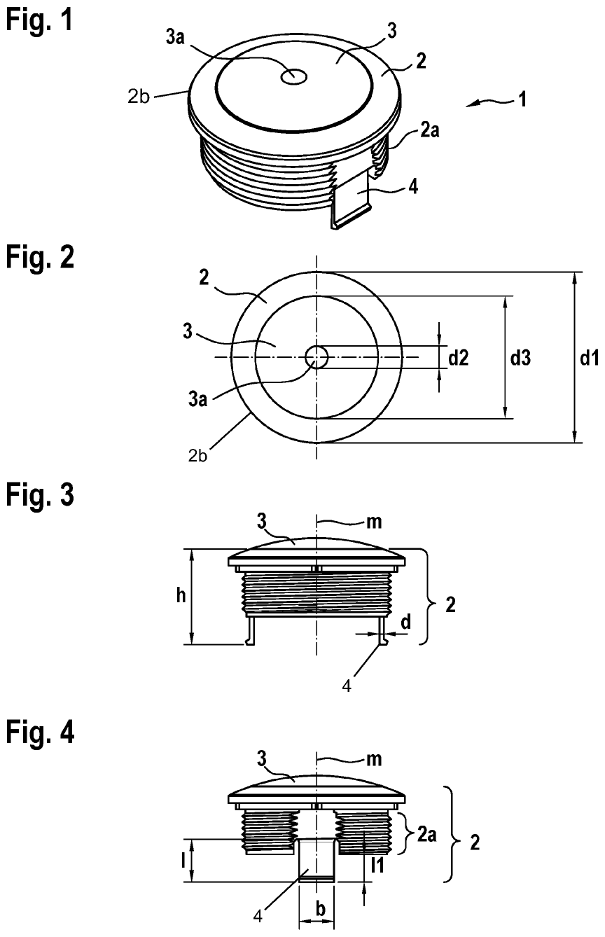

FIG. 1 shows a perspective view containing the components of an elevator pushbutton device 1 necessary to understand the invention. From this figure, a guide housing 2 and an actuating element 3 are apparent, the actuating element 3 being positioned within the guide housing 2. The guide housing 2 includes an upper portion 2b which is annular in shape, a central portion 2a extending downwardly from the upper portion 2b and provided with an external thread, and a fastening wing 4 projecting downwardly beyond the external thread. A further fastening wing is provided on the rear side of the device shown in FIG. 1 and is not apparent from FIG. 1. These fastening wings 4 are provided for fastening an electronic switch device (see FIG. 13) to the guide housing 2 of the elevator pushbutton device 1 by snapping into an inner side wall of the electronic switch device. To this end, the fastening wings must have a certain degree of stability to ensure the fastening in operation, and also a certain degree of flexibility to allow the fastening.

As can be further seen from FIG. 1, the actuating element 3 has a central recess 3a in its central region into which a transparent component can be inserted to allow light to pass through.

Furthermore, it can be seen from FIG. 1 that the surface of the actuating element 3 has a circular outer circumference and is arranged in alignment adjacent to the surface of the upper portion 2b of the guide housing 2. This ensures in the area of the surfaces of the guide housing 2 and the actuating element 3 that the distance between the guide housing and the actuating element is so small that, although a downward movement of the actuating element can be affected by pressing down the actuating element, on the other hand, when the actuating element is not actuated, penetration of, for example, disinfectant into the area between the guide housing and the actuating element is largely prevented. The surface of the actuating element may be flat or dome-shaped.

As will be explained below, the guide housing and the actuating element are each made of metal, the guide housing being a monolithic one-piece metal injection-molded component.

FIG. 2 shows a top view of the device 1 shown in FIG. 1. In this top view, the annularly formed surface of the guide housing 2 and the actuating element 3 arranged inside the guide housing with its center recess 3a are shown. The surface of the actuating element 3 may be dome-shaped and aligned with the upper portion 2b of the guide housing 2, or flat and projecting past the upper portion of the guide housing 2. Furthermore, the outer diameter d1 of the annularly formed upper end portion of the guide housing 2, the diameter d2 of the center recess 3a of the actuating element 3 and the outer diameter d3 of the actuating element 3 are illustrated.

The outer diameter d1 of the annular upper end portion 2b of the guide housing 2 is 3.429 cm+/−0.034 cm.

The diameter d2 of the center recess 3a of the actuating element 3 is 0.431 cm +/−0.04 cm.

The outer diameter d3 of the actuating element 3 is 2.489 cm+/−0.025 cm.

FIG. 3 shows a side view of the device shown in FIG. 1. This side view illustrates the device shown in FIG. 1 in a rotational position, in which the two fastening wings 4, which are offset from each other by 180° on the circumference of the guide housing 2, can be seen on the left and right. FIG. 3 further shows the height h, extending in the direction of the central axis m of the annular upper end region of the guide housing 2, of the device shown in FIG. 1. This height h is 1.905 cm+/−0.019 cm. Furthermore, the thickness d of the fastening wings 4 is illustrated in FIG. 3. This thickness d is 0.076 cm+/−0.001 cm.

FIG. 4 shows a side view of the device shown in FIG. 1 rotated by 90° compared to FIG. 3. In this side view, the length I and the width b of the fastening wings 4 are illustrated. The length I of the fastening wings is 0.863 cm+/−0.009 cm. The width b of the fastening wings is 0.762 cm+/−0.008 cm. The free length 11 of the fastening wings 4 is 0.558 cm+/−0.006 cm, wherein the free length 11 extends between the bottom of the central portion 2a of the guide housing and the bottom of the guide housing 2. Further the fastening wings 4 are flat in the direction parallel to the central axis m of the annular upper end region of the guide housing and also flat in the direction perpendicular to the central axis m of the annular shaped upper end region of the guide housing.

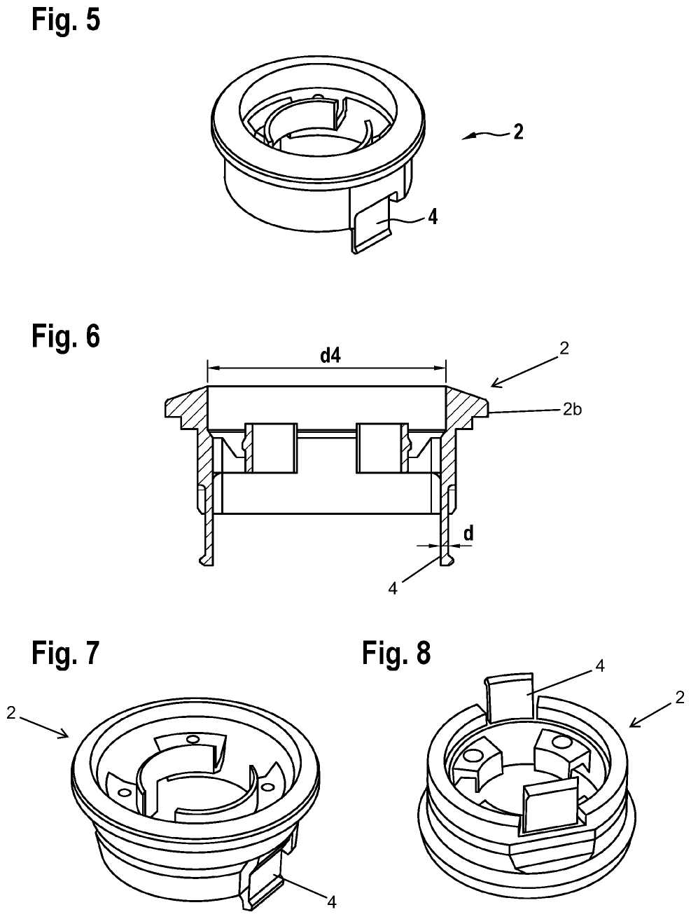

FIG. 5 shows a perspective view of the guide housing 2 from an oblique top view. In this representation, one of the two downwardly projecting fastening wings 4 is also visible.

FIG. 6 shows a sectional view of the guide housing 2. In this sectional view, the thickness d of the fastening wings 4 and the inner diameter d4 of the annular upper end region 2b of the guide housing are illustrated. This inner diameter d4 is adapted to the outer diameter d3 of the actuating element 3 and is slightly larger than d3.

FIG. 7 shows a perspective view of a guide housing 2 produced by means of a metal injection molding process from an oblique top view.

FIG. 8 shows a perspective view of a guide housing 2 produced by means of a metal injection molding process from an oblique bottom view.

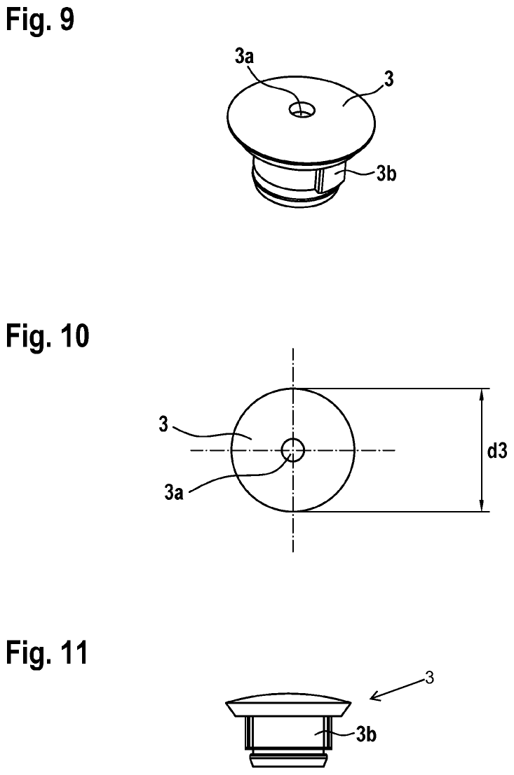

FIG. 9 shows a perspective view of the actuating element 3 from obliquely above. In this figure, among other things, the center recess 3a of the actuating element and its main body 3b arranged under the upper end portion of the actuating element are shown.

FIG. 10 shows a top view of the actuating element shown in FIG. 9. In this top view, the center recess 3a and the outer diameter d3 of the actuating element are illustrated.

FIG. 11 shows a side view of the actuating element 3 shown in FIG. 9, showing the upper end portion of the actuating element and the main body 3b located below this upper end portion.

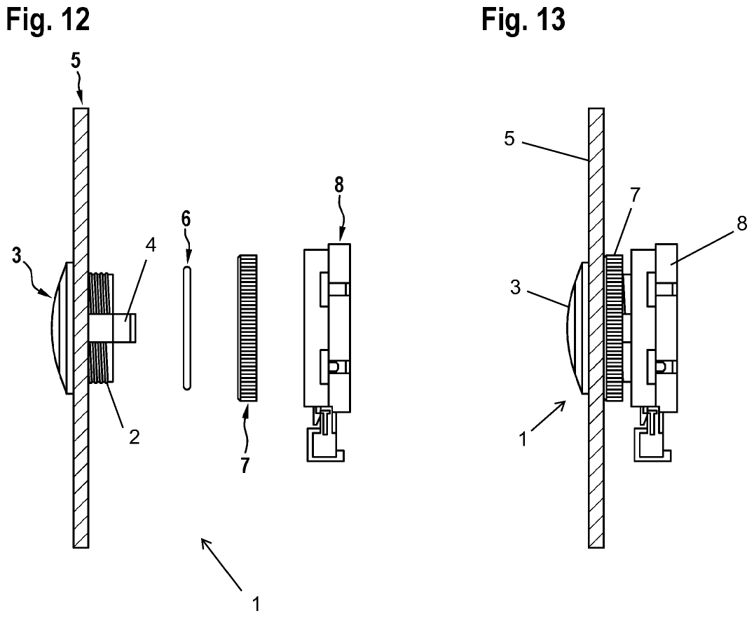

FIG. 12 shows an exploded view illustrating the attachment of an elevator pushbutton device to an elevator panel. FIG. 12 shows an elevator pushbutton device 1 with the following components: an actuating element 3, an elevator panel 5, an O-ring 6, a threaded retaining nut 7 and an electronic switch device 8. The fastening wings 4 are provided for fastening the electronic switch device 8 to the guide housing 2 of the elevator pushbutton device 1 by snapping into an inner side wall of the electronic switch device 8.

FIG. 13 shows an assembled view of the device 1 shown in FIG. 12.

As explained above, the guide housing 2 is a monolithic one-piece metal injection molded component. As part of the manufacturing process for this component, metal powder is first mixed with a polymeric binder material to provide the starting material for the manufacturing process. This starting material is then injected under high pressure into a hardened cast steel cavity using a metal injection molding machine. The binder material is then removed and the component then in place is sintered when a high temperature is present, during which it shrinks, consolidates and densifies. Suitable post-treatment can then be applied if required, for example using a sandblasting process to reduce surface roughness.

One problem with this manufacturing process is that the guide housing 2 to be produced has a complicated geometry, with varying cross-sectional areas, a high degree of concentricity, and thin fastening wings 4 that protrude freely downward. These fastening wings must be sufficiently strong to ensure the desired functionality, but must also have sufficient flexibility to mate with the electronic switch device of the elevator pushbutton device. In practice, it causes great difficulty to manufacture long and thin rod-shaped objects by means of a metal injection mold. The thinner the object to be manufactured, the more difficult the manufacturing process.

The inventors have recognized that the above dimensioning, in particular of the thin fastening wings, forms a practical compromise which, on the one hand, permits the desired manufacturability as a metal injection-molded component and, on the other hand, also provides the necessary practical compromise between necessary stability and sufficient flexibility.

These advantageous properties of the invention can also be obtained if one or more of the relationships indicated below is used for the fastening wings:

According to an embodiment the following relationship applies to the ratio between the length (I) of the fastening wings (4) and the width (b) of the fastening wings (4): 1.100<=I/b<=1.150.

According to an embodiment the following relationship applies to the ratio between the free length (11) of the fastening wings (4) and the width (b) of the fastening wings (4): 0.700<=I1/b<=0.770.

According to an embodiment the following relationship applies to the relationship between the length (I) of the fastening wings (4) and the thickness (d) of the fastening wings (4): 11.000<=I/d<=11.700.

According to an embodiment the following relationship applies to the relationship between the free length (11) of the fastening wings (4) and the thickness (d) of the fastening wings (4): 7.000<=I1/d<=7.700.

According to an embodiment the following relationship applies to the relationship between the length (I) of the fastening wings (4) and the free length (11) of the fastening wings (4): 1.500<=I/I1<=1.600.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. An elevator pushbutton device comprising:
a guide housing;
an actuating element disposed within the guide housing;
wherein the guide housing has fastening wings adapted to attach a switch device; and
wherein the guide housing and the actuating element are each formed of a metal material and the guide housing is a monolithic one-piece metal injection molded component.

15. The elevator pushbutton device according to claim 14 wherein the guide housing has an annular upper end portion.

16. The elevator pushbutton device according to claim 15 wherein an outer diameter of the upper end portion of the guide housing is 3.429 cm+/−0.034 cm and a height of the guide housing extending in a direction of a central axis of the upper end portion of the guide housing is 1.905 cm+/−0.019 cm.

17. The elevator pushbutton device according to claim 14 wherein a length of the fastening wings extending parallel to a central axis of the upper end portion of the guide housing is 0.863 cm+/−0.009 cm.

18. The elevator pushbutton device according to claim 14 wherein a free length of the fastening wings extending parallel to a central axis of the upper end portion of the guide housing and being between a lower end of a central body of the guide housing and a lower end of the guide housing is 0.558 cm+/−0.006 cm.

19. The elevator pushbutton device according to claim 14 wherein a thickness of the fastening wings extending perpendicular to a central axis of the upper end portion of the guide housing is 0.076 cm+/−0.001 cm.

20. The elevator pushbutton device according to claim 14 wherein the fastening wings are flat in a direction parallel to a central axis of the upper end portion of the guide housing and each of the fastening wings has a width of 0.762 cm+/−. 0.008 cm, wherein the width extends in a direction perpendicular to the central axis.

21. The elevator pushbutton device according to claim 14 wherein a ratio of a length of the fastening wings to a width of the fastening wings is in a range of 1.100 to 1.150.

22. The elevator pushbutton device according to claim 14 wherein a ratio of a free length of the fastening wings to a width of the fastening wings is in a range of 0.700 to 0.770.

23. The elevator pushbutton device according to claim 14 wherein a ratio of a length of the fastening wings to a thickness of the fastening wings is in a range of 11.000 to 11.700.

24. The elevator pushbutton device according to claim 14 wherein a ratio of a free length of the fastening wings to a thickness of the fastening wings is in a range of 7.000 to 7.700.

25. The elevator pushbutton device according to claim 14 wherein a ratio of a length of the fastening wings to a free length of the fastening wings is in a range of 1.500 to 1.600.

26. An elevator comprising:
an operating panel; and
at least one of the elevator pushbutton device according to claim 14 assembled in the operating panel.

27. An elevator pushbutton device comprising:
a guide housing having an annular upper end portion, a central portion extending from the upper end portion and a pair of fastening wings extending from the central portion, the fastening wings being adapted to attach a switch device to the guide housing;
an actuating element disposed within the upper end portion of the guide housing; and
wherein the guide housing and the actuating element are each formed of at least one metal material and the guide housing is a monolithic one-piece metal injection molded component.
